(19) United States
(12) Patent Application Publication
(10) Pub. No.: US 2025/0281871 A1
(43) Pub. Date: Sep. 11, 2025

(54) SYSTEM AND METHOD FOR PROVIDING ENERGY TO A CARBON CAPTURE INSTALLATION

(71) Applicant: Schlumberger Technology Corporation, Sugar Land, TX (US)

(72) Inventors: Marcus Jesen, New Plymouth (NZ); Sandeep Verma, Cambridge, MA (US)

(21) Appl. No.: 19/074,000

(22) Filed: Mar. 7, 2025

Related U.S. Application Data
(60) Provisional application No. 63/562,719, filed on Mar. 8, 2024.

(51) Int. Cl. B01D 53/14; B01D 53/02

(52) U.S. Cl. CPC B01D 53/1475; B01D 53/02; B01D 2257/504; B01D 2259/40098; B01D 2259/655

(57) ABSTRACT

A system may include a CO2 capture module, including a capture unit for capturing CO2 from a gas using a capture material and a regeneration unit for unloading the CO2 from a loaded capture material and regenerating said loaded capture material using heat. A system may include an energy module for producing electrical power and heat using solar energy, wherein at least a portion of the heat produced in the energy module is used in the regeneration unit.

### PRIORITY

The present application claims priority to and the benefit of U.S. Provisional Patent Application No. 63/562,719 filed Mar. 8, 2024, entitled “SYSTEM AND METHOD FOR PROVIDING ENERGY TO A CARBON CAPTURE INSTALLATION”, the disclosure of which is incorporated herein by reference in its entirety.

### BACKGROUND

Carbon dioxide (CO2) capture materials, such as carbon capture solvents, amines, and sorbent materials (metal-organic frameworks, Mesoporous carbon, etc.) require heat at a range of temperatures generally above 90° C., in particular between 105° C. and 150° C., to desorb CO2 from the loaded capture material and regenerate said capture material so that it can capture additional CO2 once regenerated.

### SUMMARY

The disclosure relates to a system for CO2 capture using a capture material with improved energy efficiency. The disclosure discloses an installation including a CO2 capture module, including a capture unit for capturing CO2 from a gas using a capture material and a regeneration unit for unloading the CO2 from the loaded capture material and regenerating said capture material using heat and an energy module for producing electrical power and heat using solar energy, wherein the heat produced in the energy module is used in the regeneration unit.

The gas may be atmospheric air (i.e., direct air capture), a post-combustion flue gas, a natural gas, and/or any type of gas containing CO2. The capture medium may be a solvent (such as an amine solvent, aqueous or non-aqueous), a sorbent (such as a mesoporous carbon, metal-organic framework, alkalized alumina), and/or an ion exchange material. The capture unit may include, for instance, an absorption column, a packed bed, and/or a rotating packed bed depending on the type of capture material.

The energy module includes a solar receiver that converts solar energy into electricity, for instance, a polycrystalline photovoltaic (PV) panel using high efficiency multijunction cells, and/or captures heat being produced by infrared and UV-A/UV-B wavelength of the solar spectrum, which is conventionally dissipated, for later use in a thermal storage. In some examples, the solar receiver both converts solar energy into electricity via a PV panel and captures heat via a fluid circulated therein (which may further cool the PV panel). The heatload is, for instance, stored at or below 100° C. in a hot thermal storage.

The electricity generated directly of the solar receiver may be used to run a compression chiller cycle. The compression chiller cycle may store cold thermal energy (i.e., coolth) in chilled fluid (in a cold storage) at a high coefficient of performance. In some examples, the cold thermal storage stores a liquid or slurry medium slightly above its freezing point. The electricity may also be used to power directly the CO2 capture module (such as powering fluidic devices from the fluid circuit such as the circulation pumps, valves, impurity removal devices such as gas polishing units, etc.)

The available temperature differential between the hot thermal storage and cold thermal storage can be used to evaporate and condense a refrigerant, generating electricity via a thermodynamic cycle, such as an Organic Rankine Cycle (ORC) or Kalina cycle, and/or the hot or cold energy can be dispatched directly to the CO2 module.

In the case of the CO2 capture, byproduct solar heat near the boiling point of water becomes available and can provide a significant amount of the thermal energy required to desorb CO2 from the CO2 capture materials during regeneration.

In some examples, the capture material does not require a heat higher than the boiling point of water and the heat from the thermal storage may be used directly, without any power. In such examples, the heat from the hot thermal storage may be used directly via passive heat exchange. In the case where the required regeneration temperature of the capture medium is greater that the boiling temperature of water (e.g., 105-125° C.), the hot fluid stored in the hot thermal storage may be further heated before being directed to the regeneration unit. The required heat may be obtained from the hot fluid coming from the energy module via a heat pump, and/or a heat exchanger (direct or indirect), with or without the use of a heat storing installation such as refractory bricks. In some examples, an additional heating unit includes a heat exchanger and/or heat pump that uses another source of heat (such as the flue gas heat, etc.), a resistive heating element, or a combination thereof.

In some embodiments, the hot fluid is water and may be used directly (and/or after additional heating) in the regeneration unit to desorb the CO2 from the loaded capture material. In another embodiment, the hot fluid exchanges heat with water circulating in a closed loop to deliver the required heat into the desorber material (optionally by vaporizing said water).

The electricity produced by the energy module may be used to provide the power required to run one or more of the heating units.

A significant amount of synergy value can be provided coupling the available heat from the energy module to the regeneration process. The use of renewable energy in the carbon capture installation enables to capture CO2 from any source using less energy and further limiting the CO2 indirectly needed for powering the CO2 installation. Furthermore, having heat and electricity being available to the CO2 module via the energy module enables to provide the regeneration heat in different manners, and being able to provide the heat regardless of the received solar ray, for instance in the middle of the night, as will be explained below.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a system diagram of an energy module including a solar harvesting system and a thermal cycle generator, according to at least some embodiments of the present disclosure.

FIG. 2 is a schematic diagram of a carbon dioxide (CO2) capture installation coupling an energy module and a CO2 module, according to at least some embodiments of the present disclosure.

FIG. 3 is a system diagram of another CO2 capture installation, according to at least some embodiments of the present disclosure.

FIG. 4 is a system diagram of a CO2 capture installation having a non-continuous (i.e., batch) adsorption-desorption process, according to at least some embodiments of the present disclosure.

FIG. 5 is a system diagram of an installation including an energy module with heat-storing solid units, according to at least some embodiments of the present disclosure.

FIG. 6 is a system diagram of another energy module of a CO2 capture installation, according to at least some embodiments of the present disclosure.

FIG. 7 is a system diagram of a CO2 module using high-temperature fluid of FIG. 6, according to at least some embodiments of the present disclosure.

FIG. 8 is another system diagram of a CO2 module using high-temperature fluid of FIG. 6, according to at least some embodiments of the present disclosure.

FIG. 9 is a flowchart illustrating a method of capturing CO2, according to at least some embodiments of the present disclosure.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

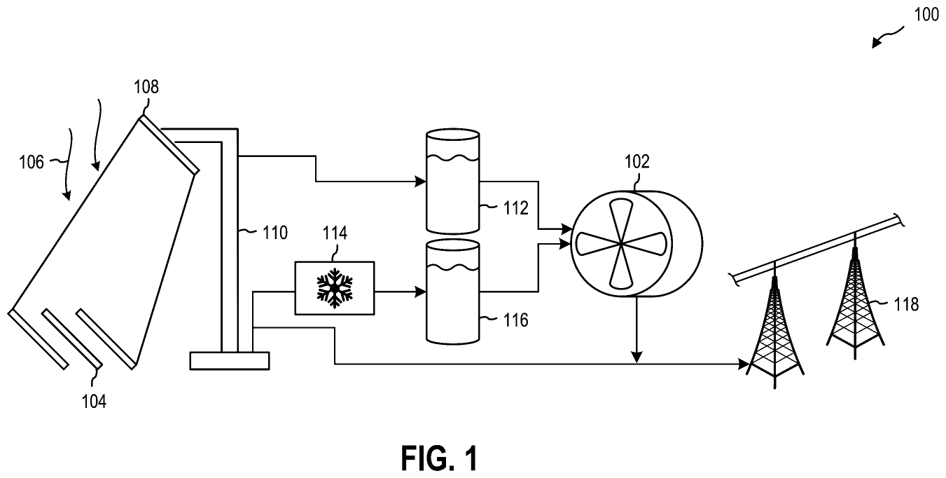

FIG. 1 illustrates such an example of an energy module 100 including a solar harvesting system and a thermal cycle generator 102, for instance a generator using an ORC (Organic Ranking Cycle) or a Kalina cycle. An example of such solar energy harvesting system is provided below. One or more mirrors 104 direct sunlight 106 onto a solar thermal collector, such as raised photovoltaic (PV) modules 108 supported by a PV module tower 110, that are actively cooled by water or other fluid circulated through the PV module tower 110. The PV modules 108 convert the sunlight 106 to energy with approximately 90% efficiency, with about 30% of the sunlight energy converted to electricity by the PV modules 108 and about 60% converted to heat. The PV module may include a multijunction cell.

The heat is captured by a circulating fluid stream, and the heat is stored in a nearby water reservoir that is the hot energy storage (HES) reservoir (first storage reservoir) 112 or heat source for the thermal cycle generator 102. The HES may contain the circulating water stream, or another fluid heated using the water stream. The fluid stored in the HES will in the following be designated as “hot fluid”.

The PV electricity may be used to power all or part of the CO2 installation, for instance an additional heating unit as will be discussed later and/or fluid distribution devices (fluid circulation devices, valves, etc.). Optionally, the PV electricity (or the grid) may be used to power a refrigeration system 114 or chiller to cool water in a second reservoir that is the cold energy storage (CES) 116 (second storage reservoir), additionally and/or alternatively from powering the CO2 installation. The streams from the HES and CES may be used as part of a thermal cycle generator to generate electricity. In particular, the thermal cycle generator 102 may be in thermal and hydraulic communication with an HES 112 and a CES 116 to provide the temperature differential to the thermal cycle generator. It uses elements to evaporate and/or condense a working fluid and a turbine for generating electricity. In some embodiments, the thermal cycle generator 102 is configured to generate electrical power based on a temperature differential between the HES 112 and the CES 116. In some embodiments without a CES 116, the thermal cycle generator 102 is configured to generate electrical power based on a temperature differential between the HES 112 and an ambient heat sink, such as exhausting heat to the ambient atmosphere.

Excess electricity produced by the thermal cycle generator may be used to power a load from the CO2 installations and/or sold to power local systems and/or sold to a power grid 118. The two thermally insulated storage reservoirs, HES 112 and CES 116, may maintain a temperature difference of approximately 90° C. For example, the temperature difference is approximately equivalent to the efficiency of a pumped hydrological system with a height difference of one kilometer. This temperature difference is exemplary, but other temperature differences may be maintained especially if the primary use of the CES is not to power the thermal cycle generator 102.

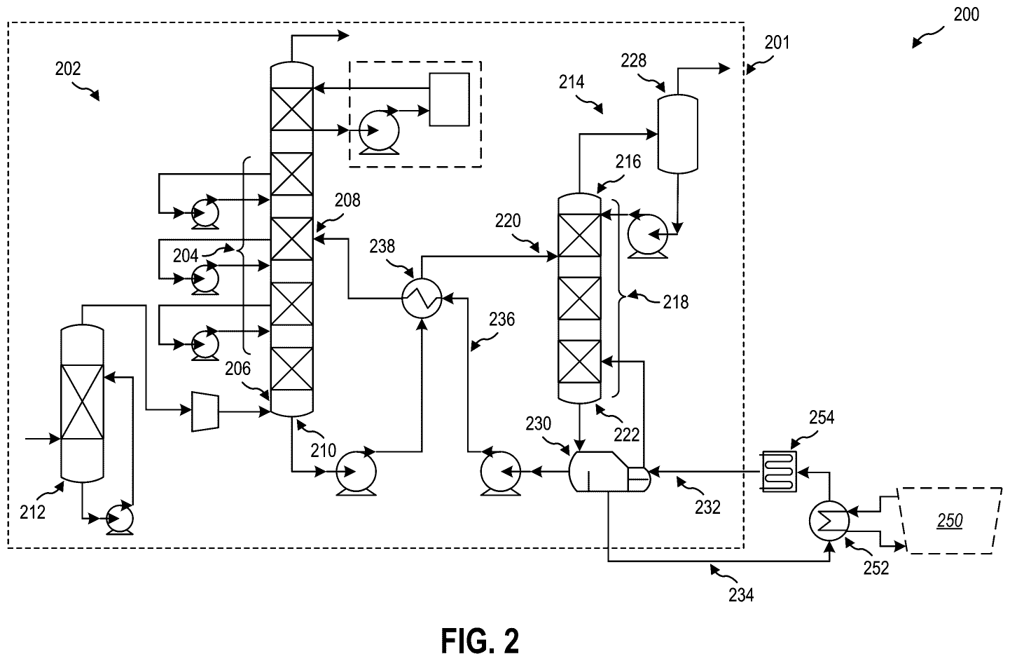

FIG. 2 shows a schematic diagram of a carbon capture installation 200 coupling an energy module (not represented in its entirety) and a CO2 module 201 according to some embodiments of the disclosure. In some embodiments, the installation 200 uses a solvent. For instance, an aqueous or non-aqueous solvent having an amine active compound.

Installation 200 includes a CO2 module 201 including a capture unit 202 having one or more absorption stage 204 in series (in the shown example, three absorption stages 204), a flue gas inlet 206 at the bottom of the capture unit, and a lean solvent inlet 208 at the top of the absorption stages 204 so that the lean solvent and the flue gas flow in the capture unit in counter-current (e.g., the lean solvent flows downward and the flue gas flows upward). Each absorption stage 204 may be configured to maximize contact between the flue gas and the lean solvent. The capture unit 202 includes an outlet 210 for the loaded (CO2 rich) solvent at the bottom of the column. The cleaned flue gas exits the absorption stages 204 at the top of the absorption stages 204. The capture unit 202 may include additional post-treatment units such as washing stages and impurity removal stage.

The CO2 module 201 may also optionally include a cooling unit 212 to cool the flue gas before it enters the capture unit 202. The CO2 module 201 also includes a regeneration unit 214 including a regeneration column 216, having one or more regeneration stages 218 in series, (in the shown example, three regeneration stages), a CO2 rich solvent inlet 220 at the top of the column and a steam inlet 222 at the bottom of the column so that the rich solvent and the steam flow in counter-current. The regeneration unit also includes an outlet 224 for CO2 loaded gas (mixed with steam) and an outlet for lean solvent 226. The regeneration unit also includes a condenser 228 downstream of the outlet 224 for condensing the steam exiting the column and redirecting it to the column and a reclaimer 230 at the bottom of the regeneration column for further purifying the lean solvent (or at least a portion thereof). In some embodiments, the reclaimer 230 is a boiler that boils a portion of the lean solvent exiting from the column using steam provided via line 232 to generate a gas phase that is withdrawn from the reclaimer and returned in the regeneration column via inlet 222, as well as a steam condensate that is withdrawn from the reclaimer at a temperature below boiling point (e.g., less than 90° C.) via line 234. In some embodiments, the reclaimer 230 is a boiler that boils a portion of the lean solvent exiting from the column using any hot fluid having a temperature greater than 90° C. In some embodiments, the reclaimer 230 boils a portion of the lean solvent using a hot fluid having a temperature between 90° C. and 150° C. Lean absorbent exiting from the reclaimer 230 is redirected to the capture unit 202 via line 236. Additional heat optimization may be provided within the CO2 module itself (for instance, the heat exchanger between lean and rich solvent—see 238).

The CO2 module 201 that has been described in relationship to FIG. 2 is an exemplary module and could, in other embodiments, include different variants and additional elements. The energy module includes a hot energy storage pit (HES) 250, as discussed in relationship with FIG. 1. The fluid contained in the HES 250 is at approximately 95° C. therefore not sufficient to provide steam. The installation comprises a heat exchanger 252 for exchanging heat between the hot fluid and the condensate that exits the reclaimer 230, raising the temperature of the condensate to approximately 90° C. The hot fluid from the HES 250 is drawn from the top of the HES 250 and eventually reinjected into the HES 250, generally at the bottom of the HES 250, at a lower temperature, such as approximately 75° C. The fluid in the HES 250 may contain dissolved elements that assist in separating the fluid having a lower temperature from fluid having higher temperature using density to maintain a thermocline therebetween.

In some embodiments, the installation 200 includes a heat pump 254 for exchanging heat between the hot fluid stored in the HES 250 and the condensate that exits the heat exchanger 252. As known in the art, the heat pump 254 includes a working fluid circuit using evaporation, compression, and condensation. The working fluid evaporates using the heat from the HES 250 (generally in a heat exchanger named evaporator) and is then compressed, increasing its temperature. Once compressed, it is cooled and condensed via heat exchange with the condensate (generally in a heat exchanger named condenser), enabling a further rise in the temperature of the condensate to approximately 120° C. The heat that may be used as an input to the heat pump may be hot fluid drawn from the top of the HES 250 at 95° C. and/or from the bottom of the HES 250 at 75° C. In some embodiments, in view of the intermediate working fluid circuit, the fluid from the HES 250 need not be hotter than the condensate to increase the temperature of the condensate. In some embodiments, the fluid at the bottom of the HES 250 is directed to the solar tower (such as the solar tower 110 described in relation to FIG. 1) in order to increase the temperature of the fluid using the solar thermal energy.

In some embodiments, the heat pump 254, namely the compressor, is powered using electricity from the energy module, e.g., the electricity provided by the PV panels and/or the heat engine. In some embodiments, the hot fluid from the HES 250 may be used to provide heat to additional units of the CO2 module, such as for instance the impurity removal/gas polishing unit or gas conditioning unit (not shown on the FIG. 2 drawing).

In some embodiments, the condensate may be heated to a temperature below the boiling point of the condensate using only a heat exchanger 252 and/or a heat pump 254 against the hot fluid. In some examples, the temperature below the boiling point of the condensate may be sufficient for regeneration.

In some embodiments, the hot fluid from the HES 250 may be heated (for instance via resistive heating) before the heat exchanger 252 so that the condensate is above boiling point at the exit of the heat exchanger 252, which may allow for bypassing the heat pump 254 or for the elimination of the heat pump 254 entirely from the system. The resistive heaters may be powered using the electricity generated by the energy module. In some embodiments, the hot fluid is directed to the heat pump 254 and/or heat exchanger 252 before reaching the HES 250. In some embodiments, another source of heat is available, such as flue gas, and such source of heat is used to heat the condensate alone or in combination with the heat exchanger 252 and/or heat pump 254 described herein.

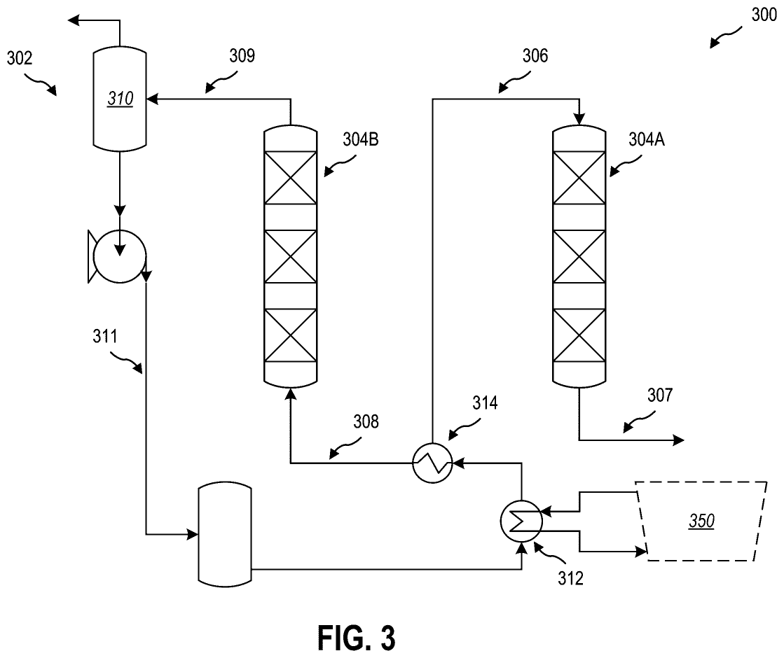

FIG. 3 shows a different embodiment of a CO2 installation 300 according to the present disclosure, used for a different type of CO2 module 302. The CO2 installation 300 includes a CO2 module 302 configured as a continuous adsorption/desorption system. In some embodiments, the CO2 module 302 has a vessel 304 including of one or more packed beds containing a capture material in a solid form. In some examples, the capture material is a sorbent. In some examples, the sorbent is mesoporous carbon. The CO2 module 302 may include, as is shown on FIG. 3, several vessels 304A, 304B. The CO2 module 302 also includes a fluid circuit having one or more fluid distribution devices to fluidly connect each of the vessel 304A, 304B to a flue gas line 306 and a clean gas line 307 for adsorption in a first configuration and to a steam line 308 and a loaded steam line 309 for desorption in a second configuration.

During a first period of time, the flue gas is circulated in the flue gas line 306 to the vessel 304A (that forms the adsorption/capture unit) in which CO2 is adsorbed by the capture material therein, and the clean gas is then discharged to the clean gas line 307. During the first period of time, the steam is circulated to the vessel 304B (that forms the regeneration/desorption unit) and loads with the CO2 from the capture material that exits the vessel 304B forming a loaded steam.

During the second period of time, the steam is circulated to the vessel 304A (that form the regeneration unit) and the flue gas to the vessel 304B (forming the adsorption/capture unit). As the steam flowing through the vessel 304B heats the loaded capture material, the CO2 loaded in the capture material is unloaded to the steam flowing therethrough. The loaded steam then exits the vessel 304B via the loaded steam line 309, and water is condensed in a condenser 310 that it leaves through water line 311 whereas the gaseous phase is discharged into the atmosphere. Lines 308, 309, 311 form a closed steam loop.

In this embodiment, the steam loop includes heat exchangers 312, 314. The heat exchangers heat the water condensate obtained from the condenser 310. The water condensate obtained from the condenser 310 may be approximately 70° C., and the heat exchanger(s) 312, 314 boil the condensate back into steam. In the first heat exchanger 312, the hot fluid from the HES 350 of the energy module (such as the HES 250 and/or energy module described in relation to FIG. 2) and the condensate circulate, increasing the temperature of the condensate to approximately 90° C. In the second heat exchanger 314, the flue gas circulates against the heated condensate and elevates the temperature of the condensate above the boiling point. In some embodiments, the condensate is heat to approximately 120° C.

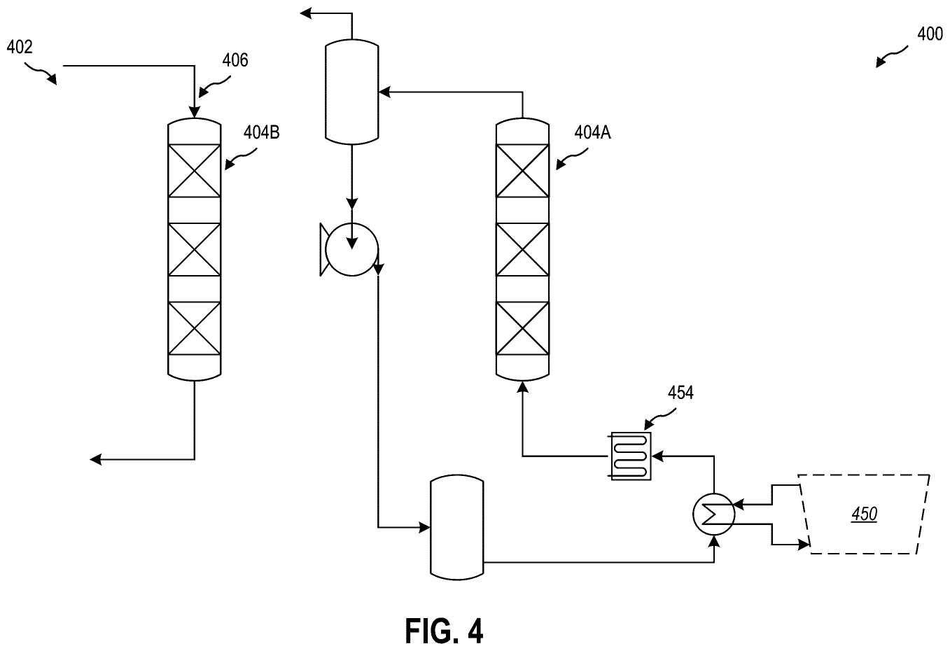

As shown on FIG. 4, a similar principle is applied to another embodiment of a CO2 installation 400 having a non-continuous (i.e., batch) adsorption-desorption process. In a non-continuous process, the condensate does exchange heat against the flue gas and the heat exchanger 314 of FIG. 3. In some embodiments, the heat exchanger 314 is replaced by a heat pump 454 using the hot fluid from the HES 450 to raise temperature of the condensate (such as described in relation to FIG. 2). In some embodiments, the vessels 404A, 404B are connected to the heat source (such as the heat pump and/or exchanger) to heat and desorb the CO2 from the absorbent bed sequentially. For example, a first vessel 404A is recharged by the application of heat from the HES 450 while a second vessel 404B is connected to a CO2-rich flue gas line 406. Upon complete or nearly complete desorption of the absorbent bed of the first vessel 404A and/or saturation of the absorbent bed of the second vessel 404B, the first vessel 404A and second vessel 404B may be switched in connection with the heat source. In some embodiments, more than two vessels are used to facilitate maintenance, storage, and/or reduce downtime of the installation 400.

Other embodiments as explained in relation to FIG. 2 may be applied to FIG. 3 and/or 4, i.e., using a heat pump instead of a heat exchanger 312, additionally heating the hot fluid before heat exchanging it with the condensate, etc. The CO2 module may also include many variations, and the current disclosure is applicable to any CO2 capture system, regardless of the capture medium or of the particular architecture of said module.

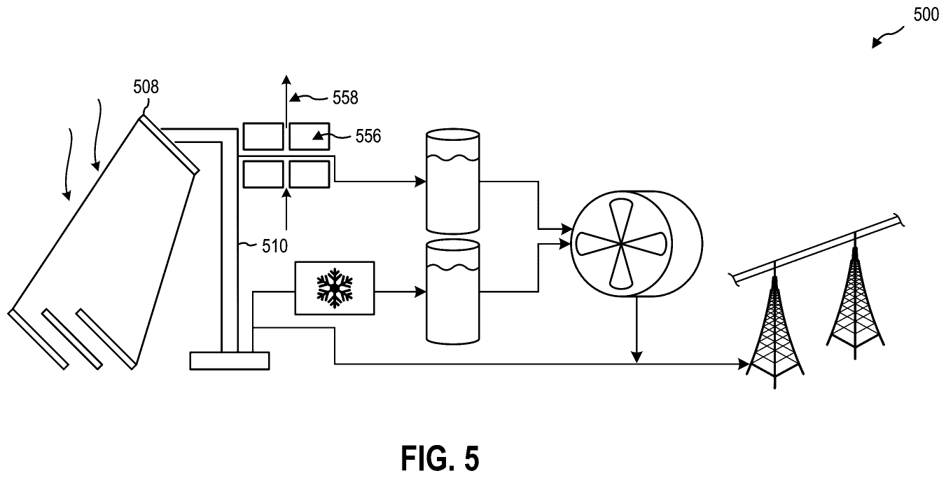

FIG. 5 is a system diagram of an installation 500 including an energy module similar to that described in relation to FIG. 1, and the installation 500 may include heat-storing solid units 556 (such as refractory bricks). In some embodiments, the heat-storing solid units 556 are heated using the fluid stream that has recovered thermal energy from the solar panels PV modules 508 and/or the solar tower 510 via a heat exchanger. A condensate line 558 of a CO2 module (such as CO2 modules 201, 302, 402 described in relation to FIG. 2, FIG. 3, and FIG. 4) may circulate through the heat-storing solid units 556 so as to be heated and/or pre-heated via a heat exchanger to a temperature of approximately 90° C. In another embodiment, the heat-storing solid units may be disposed in the hot fluid loop and/or in the condensate line and may replace and/or supplement other heating devices in the fluid loop (for instance, instead of the heat exchanger 252 in FIG. 2). In some embodiments, the heat-storing solid units are combined with any other additional heating element. In some embodiments, the installation includes a heat exchanger and/or heat pump to exchange heat between the hot fluid and the condensate stream in addition to the heat storing solid units.

In at least one embodiment, the solar tower includes two solar receivers, one as explained in relation to FIG. 1 that recovers electricity and heat, and a second that is configured to recover only heat. In such an embodiment, all solar energy converted by the second solar receiver is converted to thermal energy and used to produce a hot fluid stream at a higher temperature than the 90° C. obtained using the system described in FIG. 1. In some embodiments, the hot fluid stream is used to raise the temperature of the condensate stream above its boiling point without using a heat pump, but rather through passive heat exchange.

In an embodiment, when the installation includes passive heat exchanger (via direct heat exchanger or indirect heat exchange using heat storing solid units) and a heat pump, the heat pump may be powered only in case the passive heat exchange is not able to bring the condensate stream at the right temperature. In that case, the installation may include a controller implementing control schemes for powering the heat pump based on a temperature sensor reading obtained in the condensate line, at the outlet of the heat exchanger. Such control may be beneficial to supply the required heat during the night, when no solar thermal energy is recovered.

In some instances, the electricity and heat generated by the energy module in real-time are sufficient to heat the regeneration stream and power the refrigeration unit, so that the heat engine is not running. This is, for instance, the case when the sun is shining and is close to the zenith.

In some instances, electricity and heat generated by the energy module are insufficient to power the heating units and the refrigeration unit, for instance in the night. However, it may be necessary that the CO2 capture installation continues to operate in such instances. In such a case, the thermal cycle generator (such as the thermal cycle generator 102 described in relation to FIG. 1) may operate using the thermal energy stored in the HES (and/or CES, as described above), so that additional heating units may be used to heat the regeneration stream in replacement or in addition to the heating units used when solar energy is available to the installation. The thermal cycle generator may be triggered by a sensor reading, in particular a temperature of the regeneration stream (i.e., condensate or steam) at the inlet of the regeneration unit and/or the solar energy received by the solar receiver.

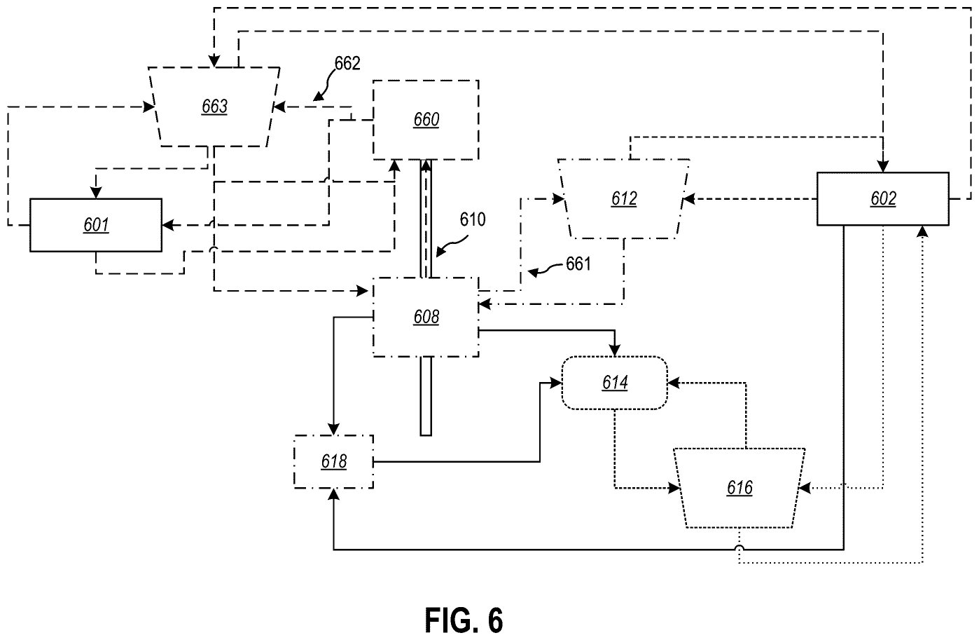

FIG. 6 is a system diagram of an embodiment of an energy module of a CO2 capture installation 600. In some embodiments, the energy module is part of a direct air capture (DAC) installation. It should be understood that the embodiment of an energy module described in relation to FIG. 6 may be used with non-DAC installations, as well. In some embodiments, a DAC installation 600 according to the present disclosure includes a solar tower 610 that includes a first solar receiver 608 including a PV module that converts a portion of the solar energy to electricity and a thermal receiver that collects solar thermal energy in a fluid loop of a first fluid 661, ie hot fluid, to provide approximately 90° C. fluid to the HES 612, such as described in relation to FIG. 1. In some embodiments, the energy module of the DAC installation 600 further includes a refrigeration unit 614 configured to charge a CES 616. In some embodiments, the HES 612 and CES 616 provide the temperature differential to operate a thermal cycle generator 602. In some embodiments, the installation 600 lacks a CES 616 and/or refrigeration unit 614, and the thermal cycle generator 602 operates on a temperature differential between a heat source (such as the first fluid 661 and/or second fluid 662, as will be described herein) and ambient temperature. The thermal cycle generator 602 and/or the PV module 608 may export electrical power to a grid 618 or a local electrical storage device, such as batteries. In some embodiments, the refrigeration unit 614 is configured to receive electricity from the grid 618 or local electrical storage device.

In some embodiments, the DAC installation 600 further includes a second solar receiver including a thermal receiver 660 in the solar tower 610 (and/or, optionally, a second thermal receiver in a second solar tower) that raises a temperature of a high-temperature second fluid 662 to greater than 90° C., such as greater than 100° C. or up to approximately 150° C. In some embodiments, the high-temperature second fluid 662 may be pressurized water, steam, oil, or other gaseous or liquid fluid. In some embodiments, the high-temperature second fluid 662 is in a temperature range of 120° C. and 150° C. In some embodiments, the hot first fluid 661 and the high-temperature second fluid 662 are the same fluid in separate closed loops. In some embodiments, the hot first fluid 661 and the high-temperature second fluid 662 are different fluids. For example, the first fluid 661 may be water, and the second fluid 662 may be oil. In some embodiments, the first fluid 661 and the high-temperature second fluid 662 are the same fluid and intermix in at least one location in the installation 600. For example, a single shared fluid may be heated to approximately 90° C. in the first solar receiver 608, and a first portion of the shared fluid is diverted to the HES 612 as a hot first fluid 661 while a second portion of the shared fluid is diverted to toward the second solar receiver including the thermal receiver 660, which heats the second portion into the high-temperature second fluid 662 with a temperature greater than 100° C. that circulates in another part of the installation 600. The system may include to this effect a fluid distribution device and a controller to control the flow of the fluid exiting the first solar receiver 608 to the HES and the second solar receiver 660 respectively. Such distribution may be based on parameters of the CO2 module 601, and/or of the HES (thermocline level for instance).

As explained above, the HES and/or HTES have a temperature that vary between the top and the bottom of the pit. The temperature at the top of the pit is higher than the temperature at the bottom. In the embodiment of FIG. 6, a pipe connects the bottom of the HES 612 to the first solar receiver so that fluid from the HES recirculates through the first solar receiver to be heated by the first and/or second solar receiver. A pipe connects the bottom of the HTES to the first and/or second solar receivers so that fluid from the HTES recirculates through the first and/or second solar receiver to be heated by the first solar receiver.

In some embodiments, a fluid entering the thermal receiver 660 has a temperature less than 100° C., and the high-temperature fluid 662 exiting the thermal receiver 660 has a temperature greater than 100° C. In some embodiments, a fluid entering the thermal receiver 660 has a temperature less than 120° C., and the high-temperature fluid 662 exiting the thermal receiver 660 has a temperature greater than 120° C. In some embodiments, the installation 600 includes a first thermal receiver and a second thermal receiver in series (which, as described herein, may be on a separate solar tower). In such an example, high-temperature fluid 662 exiting the first thermal receiver has a temperature less than 120° C., and the high-temperature fluid 662 exiting the second thermal receiver has a temperature greater than 120° C.

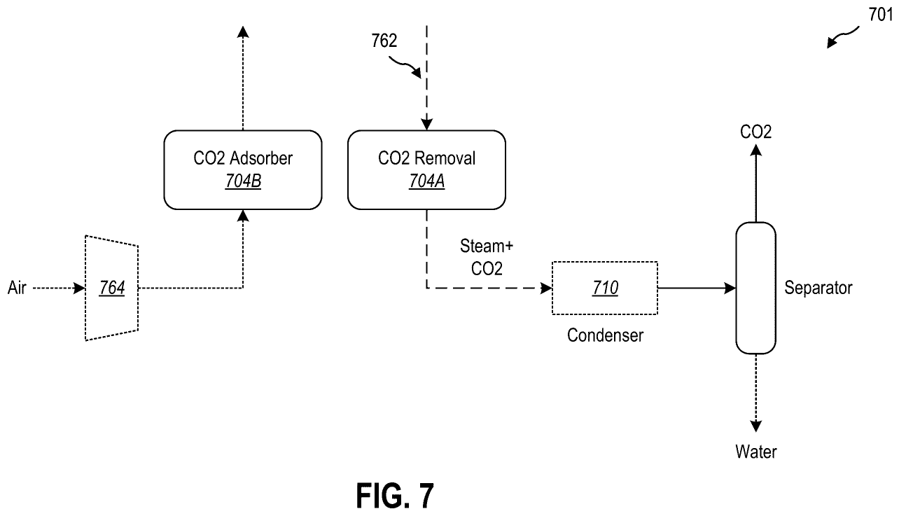

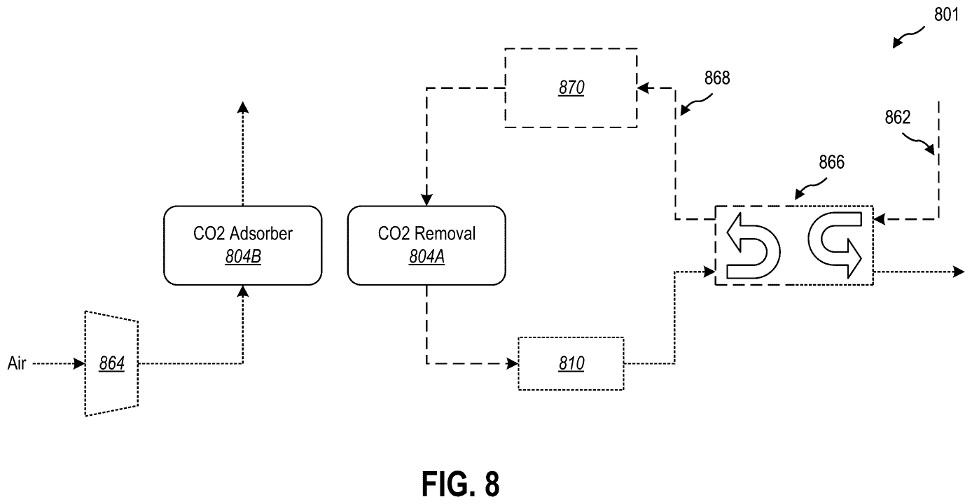

In some embodiments, at least a portion of the high-temperature fluid 662 is distributed from the thermal receiver 660 to the HES 612. In some embodiments, at least a portion of the high-temperature second fluid 662 is distributed from the thermal receiver 660 to a CO2 module 601 (as will be described in more detail in relation to FIGS. 7 and 8). In some embodiments, least a portion of the high-temperature second fluid 662 is distributed from the thermal receiver 660 to a high-temperature energy storage (HTES) 663. In some embodiments, the HTES 663 is pit storage similar to that described in relation to a HES and/or CES. In some embodiments, the HTES 663 is configured to store the high-temperature fluid (at a temperature higher than the fluid stored in the HES) and provide high-temperature second fluid 662 to the CO2 module 602 and/or to the HES 612 to increase a temperature thereof. The system may include a fluid distribution device and a controller to control the flow of the fluid exiting the thermal receiver 660 to the HES/HTES or CO2 module respectively based on the parameters of the CO2 module and/or the HES/HTES.

In some embodiment, the HES and/or HTES are configured to provide fluid at the bottom of the pit (having a lower temperature) to circulate back to the solar receivers. For instance, there is a fluid conduit between the bottom of the HES and HTES pits to the first solar receiver 608. However, other configurations are possible.

In some embodiments, the HTES 663 is configured to provide high-temperature second fluid 662 to the thermal cycle generator 602. For example, the thermodynamic efficiency of the thermal cycle generator 602 may be increased with a higher temperature heat source than the first fluid 661 of the HES 612. In particular, a thermal cycle generator 602 operating with an ambient temperature heat sink may benefit from the high-temperature second fluid 662 (either directly from the thermal receiver 660 or from the HTES 663) as a heat source.

A DAC installation may be configured to capture CO2 directly from the atmosphere. Atmospheric CO2 is much lower concentration than a post-combustion flue gas. For example, ambient atmosphere is approximately 0.2% CO2, while post-combustion combustion flue gas may be in a range of 2% to 30% CO2. Energy efficiency is therefore critical to a DAC installation.

FIG. 7 and FIG. 8 illustrate different applications of the high-temperature second fluid 662 described in relation to FIG. 6 to improve efficiency in a DAC installation. FIG. 7 illustrates an embodiment of a CO2 module 701 including direct injection of a high-temperature fluid 762, such as the high-temperature second fluid 662 described in relation to FIG. 6 in which the high-temperature fluid 762 has a temperature greater than 90° C. In some embodiments, the high-temperature fluid 762 has a temperature greater than 100° C. In some embodiments, the high-temperature fluid 762 has a temperature between 100° C. and 150° C.

The high-temperature fluid 762 is, in some embodiments, directed from a thermal receiver (such as the thermal receiver 660 described in relation to FIG. 6) directly to a first vessel 704A containing a loaded capture material (adsorbent or absorbent). The high-temperature fluid 762 heats the loaded absorbent, which subsequently desorbs CO2. A loaded fluid flow (containing steam or other fluid) flows from the first vessel 704A to a condenser 710. In some embodiments utilizing steam in the high-temperature fluid 762, the condenser 710 exhausts heat from the loaded fluid flow, and the condensate and CO2 flow to a separator or other component that diverts the condensate water and CO2. In some embodiments, the condensate fluid (e.g. water) is recycled to the solar tower and thermal receiver to be heated again. In some embodiments, the condensate fluid is recycled to an HES.

In some embodiments, a second vessel 704B includes an absorbent/adsorbent that captures atmospheric CO2. In some embodiments, the DAC installation further includes a blower 764 configured to collect and/or compress atmospheric air into a second vessel 704B containing the absorbent/adsorbent. In some embodiments, the blower 764 is powered by electricity generated by the thermal cycle generator (e.g., ORC generator) such as described in relation to FIG. 1 and FIG. 5. In some embodiments, the blower 764 is powered by electricity generated by the PV modules such as the PV modules 108, 508 described in relation to FIG. 1 and FIG. 5). As noted herein, the CO2 concentration in atmospheric air is one to two orders of magnitude less than a post-combustion or industrial flue gas (approximately 0.04% compared to 2%-30% on a weight basis, respectively). In some embodiments, the blower 864 forces an increased flowrate of atmospheric air through the capture unit, thereby increasing amount of CO2 the absorbent/adsorbent is exposed to and/or contacted with. The blower 864 may, therefore, increase the capture rate of the capture unit. In some embodiments, the blower 864 further compresses the atmospheric air. Compression of the atmospheric air into to the second vessel 704B and across and/or through the absorbent/adsorbent can increase the mass of CO2 exposed to the absorbent/adsorbent for the same volume of airflow therethrough. In some embodiments, the installation does not include the blower 764 or 864 and the natural air circulation is used for adsorption.

FIG. 8 illustrates another embodiment of a CO2 module 801 including a heat exchanger 866 configured to receive a high-temperature fluid 862, such as the high-temperature fluid 662 described in relation to FIG. 6. In some embodiments, the high-temperature fluid 862 has a temperature greater than 90° C. In some embodiments, the high-temperature fluid 862 has a temperature greater than 100° C. In some embodiments, the high-temperature fluid 862 has a temperature between 100° C. and 150° C.

The high-temperature fluid 862 is, in some embodiments, directed from a thermal receiver (such as the thermal receiver 660 described in relation to FIG. 6) to a heat exchanger 866 (which may be similar to the heat exchanger 312 described in relation to FIG. 3). In some embodiments, the heat exchanger 866 transfers heat from the high-temperature fluid 862 to a closed fluid loop 868 including a working fluid configured to flow into and/or through a first vessel 804A. In some embodiments, the working fluid is water. In some examples, the heat exchanger 866 vaporizes the water into steam that is circulated through the first vessel 804A. In some embodiments, the working fluid is water that does not vaporize and remains liquid water through the closed fluid loop 868. In some embodiments, the closed fluid loop 868 further includes a heater 870 configured to heat the working fluid above a temperature of the high-temperature fluid 862. For example, the high-temperature fluid 862 may have a temperature less than the boiling temperature of the working fluid, and the heater 870 may heat and/or vaporize the working fluid prior to injection into the first vessel 804A. In some embodiments, the working fluid is not water. For example, the working fluid may be an oil.

In some embodiments, the working fluid in the closed fluid loop 868 heats the loaded absorbent in the first vessel 804A, which subsequently desorbs CO2. A loaded fluid flow (containing steam or other working fluid) flows from the first vessel 804A to a condenser 810. In some embodiments utilizing steam in as the working fluid, the condenser 810 exhausts heat from the loaded fluid flow, and the condensed working fluid and CO2 flow to a separator or other component that diverts the condensate water and CO2. In some embodiments, the condensed working fluid (e.g. water) is recycled to the heat exchanger 866 through the closed fluid loop 868, while the cooled fluid 862 is recycled to the thermal receiver to be heated again. In some embodiments, the cooled fluid 862 is recycled to an HES.

Similar to the embodiment described in relation to FIG. 7, in some embodiments, a second vessel 804B includes an absorbent/adsorbent that captures atmospheric CO2. In some embodiments, the DAC installation further includes a blower 864 configured to collect and/or compress atmospheric air into a second vessel 804B containing the absorbent/adsorbent. In some embodiments, the blower 764 is powered by electricity generated by the thermal cycle generator (e.g., ORC generator) such as described in relation to FIG. 1 and FIG. 5. In some embodiments, the blower 764 is powered by electricity generated by the PV modules such as the PV modules 108, 508 described in relation to FIG. 1 and FIG. 5). As noted herein, the CO2 concentration in atmospheric air is one to two orders of magnitude less than a post-combustion flue gas (approximately 0.4% compared to 2%-30% on a weight basis, respectively). In some embodiments, the blower 864 forces an increased flowrate of atmospheric air through the capture unit, thereby increasing amount of CO2 the absorbent/adsorbent is exposed to and/or contacted with. The blower 864 may, therefore, increase the capture rate of the capture unit. In some embodiments, the blower 864 further compresses the atmospheric air. Compression of the atmospheric air into to the second vessel 804B and across and/or through the absorbent/adsorbent can increase the mass of CO2 exposed to the absorbent/adsorbent for the same volume of airflow therethrough.

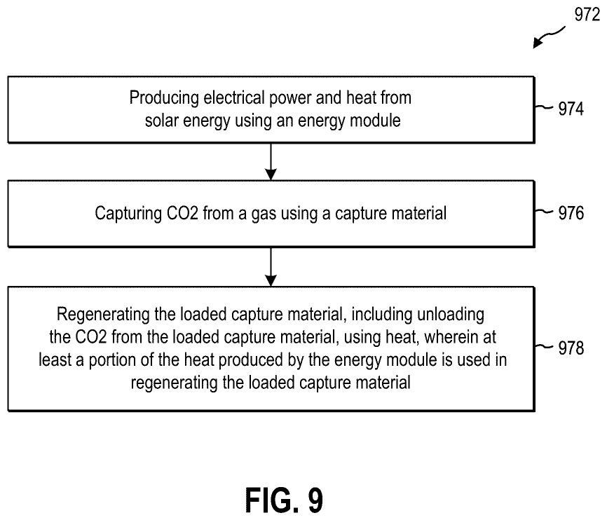

FIG. 9 is a flowchart illustrating an embodiment of a method 972 of capturing CO2. In some embodiments, the method 972 includes producing electrical power and heat from solar energy using an energy module at 974. In some embodiments, the energy module is any embodiment of an energy module described herein, such as in relation to FIG. 1. In some embodiments, the energy module includes a solar tower configured to convert at least a first part of the solar energy into solar electrical power via one or more PV modules and at least a second part of the solar energy into solar thermal power (e.g., heat) via a fluid circulating through the solar tower. In some embodiments, the energy module includes a first solar receiver or tower configured to convert at least a first part of the solar energy into solar electrical power via one or more PV modules and a second solar tower or receiver configured to convert at least a second part of the solar energy into solar thermal power (e.g., heat) via a fluid circulating through the second solar tower. In some embodiments, the first solar receiver or tower is configured to convert the solar energy into solar electrical power and into solar thermal power while the second solar receiver is configured to convert the solar energy into solar thermal power only. A higher amount of solar energy is therefore converted into solar thermal power in the second receiver than in the first one. In some embodiments, the energy module further includes a thermal cycle generator configured to use at least a portion of the solar heat to produce electrical power. In some embodiments, the energy module further includes an HES, as described herein. In some embodiments, the energy module further includes a CES, as described herein.

In some embodiments, the method 972 further includes capturing CO2 from a gas using a capture material at 976. In some embodiments, the capture material is an absorbent. In some embodiments, the capture material is an adsorbent. In some embodiments, the capture material is or includes carbon capture solvents, amines, and sorbent materials (metal-organic frameworks, Mesoporous carbon, etc.) In some embodiments, the capture material is a solid. In some embodiments, the capture material is a liquid.

In some embodiments, the gas is atmospheric air. In some embodiments, capturing the CO2 includes compressing the atmospheric air prior to exposing the capture material to the atmospheric air. In some embodiments, the gas is post-combustion flue gas. In some embodiments, capturing the CO2 includes compressing the post-combustion flue gas prior to exposing the capture material to the post-combustion flue gas. In some embodiments, capturing the CO2 includes cooling the post-combustion flue gas prior to exposing the capture material to the post-combustion flue gas. In some embodiments, the gas is natural gas. In some embodiments, capturing the CO2 includes compressing the natural gas prior to exposing the capture material to the natural gas. In some embodiments, capturing the CO2 includes cooling the natural gas prior to exposing the capture material to the natural gas.

In some embodiments, the method 972 further includes regenerating the loaded capture material, including unloading the CO2 from the loaded capture material, using heat, wherein at least a portion of the heat produced by the energy module is used in regenerating the loaded capture material at 978. In some embodiments, the heat is provided from an HES of the energy module. In some embodiments, the heat is provided by a hot working fluid of the HES transferring heat to the loaded capture material. In some embodiments, the heat is provided to a closed fluid loop (e.g., a regeneration stream, as described herein) via a heat exchanger in thermal communication with the HES and/or hot fluid thereof. In some embodiments, the heat is provided directly from a thermal receiver of a solar tower of the energy module. In some embodiments, the heat is provided a liquid working fluid (e.g., water). In some embodiments, the heat is provided a gaseous working fluid (e.g., steam). In some embodiments, the working fluid that regenerates the capture material has a temperature greater than 90° C. when transferring heat to the capture material. In some embodiments, the working fluid that regenerates the capture material has a temperature greater than 100° C. when transferring heat to the capture material. In some embodiments, the working fluid that regenerates the capture material has a temperature greater than 120° C. when transferring heat to the capture material.

The present disclosure relates generally to a combined carbon capture and electrical power generation installation and methods of operation thereof according to at least the following clauses:

Clause 1. A CO2 capture installation, comprising: a CO2 capture module, including a capture unit for capturing CO2 from a gas using a capture material and a regeneration unit for unloading the CO2 from the loaded capture material and regenerating said capture material using heat; and an energy module for producing electrical power and heat using solar energy, wherein at least a portion of the heat produced in the energy module is used in the regeneration unit.

Clause 2. The CO2 capture installation according to the preceding clause, wherein the heat produced in the energy module is used to heat a regeneration stream to be circulated in the regeneration unit to a temperature greater than 90° C., optionally 105° C.

Clause 3. The CO2 capture installation according to any preceding clause, wherein the energy module includes at least one solar receiver for receiving solar rays, a hot fluid circulating in the solar receiver to recover thermal energy from the solar rays and a storage pit, optionally thermally insulated, for storing the hot fluid.

Clause 4. The CO2 capture installation according to the preceding clause, wherein the solar receiver is mounted on a solar tower and wherein the energy module includes one or more mirrors, optionally having an adjustable orientation, to direct the solar rays to the solar receivers.

Clause 5. The CO2 capture installation according to clause 3 or 4, comprising one or more heat exchangers, such as a direct or indirect heat exchanger, for exchanging heat between the hot fluid and the regeneration stream.

Clause 6. The CO2 capture installation according to the preceding clause, wherein the heat exchanger includes a heat storing installation comprising solid heat storing units, such as refractory bricks, configured so that the hot fluid and the regeneration stream both exchange heat with the solid heat storing elements.

Clause 7. The CO2 capture installation according to the preceding clause, comprising a hot fluid line from the solar receiver to the storage pit wherein the heat storing installation is upstream from the storage pit in the hot fluid line.

Clause 8. The CO2 capture installation according to any of clauses 5-7, including a hot fluid loop to fluidly connect the storage pit to at least one of the heat exchangers.

Clause 9. The CO2 capture installation according to any of clauses 2-8, including a heat pump wherein the hot fluid circulates in an evaporator of the heat pump, and the regenerating stream circulates in a condenser of said heat pump.

Clause 10. The CO2 capture installation of the preceding clause, including a hot fluid loop to fluidly connect the storage pit to the heat pump.

Clause 11. The CO2 capture installation according to clauses 9-10, comprising a regeneration stream line for carrying the regeneration stream to the regeneration unit, wherein the heat exchanger is situated in the regeneration stream line upstream from the condenser of the heat pump, so that the regeneration stream at the outlet of the heat exchanger has a first temperature and has a second temperature higher than the first temperature, and optionally higher than its boiling point, at the outlet of the heat pump.

Clause 12. The CO2 capture installation of the preceding clause, including a controller for powering the heat pump based on a temperature of the regeneration stream at the outlet of the heat exchanger.

Clause 13. The CO2 capture installation of any preceding clause, comprising one or more additional heating unit not using the heat produced by the energy module, optionally including one or more additional heat exchangers, additional heat pumps, resistive heating elements, etc.

Clause 14. The CO2 capture installation according to any preceding clause, wherein at least one of the solar receivers of the energy module is a photovoltaic solar panel and generates electricity.

Clause 15. The CO2 capture installation of the preceding clause, wherein the electricity generated by the photovoltaic solar panel is used to power the heat pump and/or an additional heating element and/or an element of the CO2 module, such as a fluid circulation pump, a valve.

Clause 16. The CO2 capture installation of any preceding clause, wherein the storage pit is a hot storage pit, wherein the energy module further includes a refrigeration unit to cool a cold fluid and a cold storage pit, optionally thermally insulated, to store the cold fluid.

Clause 17. The CO2 capture installation of the preceding clause, wherein electricity generated by a photovoltaic solar panel of the energy module is used to power the refrigeration unit.

Clause 18. The CO2 capture installation of the preceding clause, wherein the hot fluid and cold fluid are used in a heat engine, such as an ORC generator or a Kalina generator, to generate electricity.

Clause 19. The CO2 capture installation of any preceding clause, wherein the energy module includes a first solar receiver that produces electricity and heat and a second solar receiver that produces heat, wherein a first hot fluid circuit is configured so that a first hot fluid recovers thermal energy from the first solar receiver and a second hot fluid circuit is configured so that a second hot fluid recovers thermal energy from the second receiver.

Clause 20. The CO2 capture installation of the preceding clause, wherein the second hot fluid exchanges heat with the regeneration stream and the first hot fluid is stored in the hot storage pit without exchanging thermal energy with the regeneration stream for use in the heat engine.

Clause 21. The CO2 capture installation of any preceding clause, wherein the capture material is a solvent, a sorbent, or an ion exchange unit, or combination thereof.

Clause 22. The CO2 capture installation of any preceding clause, wherein the gas is atmospheric air, post-combustion flue gas, a natural gas.

Clause 23. The CO2 capture installation of any preceding clause, wherein the regeneration stream is steam.

Clause 24. The CO2 capture installation of any preceding clause, wherein the capture unit includes one or more packed beds, a rotating packed bed, an absorption column, a structured sorbent for circulating the gas counter current with the capture material.

Clause 25. A method for CO2 capture comprising: producing electrical power and heat from solar energy using an energy module, capturing CO2 from a gas using a capture material, regenerating the loaded capture material, including unloading the CO2 from the loaded capture material, using heat, wherein at least a portion of the heat produced by the energy module is used in the regenerating of the loaded capture material.

Clause 26. The method according to any preceding clause, wherein regenerating the loaded capture material includes heating a regeneration stream to a temperature greater than 90° C., optionally 105° C., wherein the regeneration stream is optionally steam.

Clause 27. The method according to any clause 25-26, wherein producing heat from solar energy includes receiving solar rays at least at one solar receiver, circulating a hot fluid in the solar receiver to recover thermal energy from the solar rays and storing the hot fluid in a hot storage pit, optionally thermally insulated.

Clause 28. The method according to the preceding clause, wherein the solar receiver is mounted on a solar tower and producing heat from solar energy includes directing one or more mirrors receiving the solar rays, optionally having an adjustable orientation, to the at least one solar receiver.

Clause 29. The method according to clause 27 or 28, comprising exchanging heat between the hot fluid and the regeneration stream via one or more heat exchangers, such as a direct or indirect heat exchanger.

Clause 30. The method according to the preceding clause, wherein exchanging heat includes storing heat from the hot fluid in a heat storing installation comprising solid heat storing units, such as refractory bricks, and unloading heat from the heat storing installation in the regeneration stream.

Clause 31. The method according to the preceding clause, wherein storing heat from the hot fluid in the heat storing installation is performed while the hot fluid circulates from the one or more solar receivers to the storage pit.

Clause 32. The method according to any of clauses 29-31, wherein exchanging heat between the hot fluid and the regeneration stream via at least one heat exchanger includes circulating the hot fluid from the storage pit to the heat exchanger and back to the storage pit.

Clause 33. The method according to any of clauses 27-32, comprising exchanging heat between the hot fluid and the regeneration stream via one or more heat pump, including circulating the regenerating stream circulates in a condenser of said heat pump and circulating the hot fluid in an evaporator of said heat pump.

Clause 34. The method of the preceding clause, wherein exchanging heat between the hot fluid and the regeneration stream via at least one heat pump includes circulating the hot fluid from the storage pit to the heat pump and back to the storage pit.

Clause 35. The method according to any of clauses 33-34, comprising circulating the regeneration stream to the heat exchanger and then to the condenser of the heat pump, so that the regeneration stream at the outlet of the heat exchanger has a first temperature and has a second temperature higher than the first temperature, and optionally higher than its boiling point, at the outlet of the heat pump.

Clause 36. The method of the preceding clause, including powering the heat pump based on a temperature of the regeneration stream at the outlet of the heat exchanger.

Clause 37. The method of any preceding clause, comprising additional heating the regeneration stream without using the heat produced by the energy module, optionally including one or more additional heat exchangers, additional heat pumps, resistive heating elements, etc.

Clause 38. The method of any preceding clause, wherein producing electricity including using a photovoltaic solar panel from the energy module, wherein the photovoltaic panel optionally also provides heat.

Clause 39. The method of the preceding clause, including using the electricity generated by the photovoltaic solar panel to power the heat pump and/or an additional heating element and/or an element of the CO2 module, such as a fluid circulation pump, a valve.

Clause 40. The method of any preceding clause, wherein the storage pit is a hot storage pit, further including powering a refrigeration unit to cool a cold fluid and storing the cold fluid in a cold storage pit, optionally thermally insulated.

Clause 41. The method of the preceding clause, wherein the electricity generated by the photovoltaic solar panel is used to power the refrigeration unit.

Clause 42. The method of the preceding clause 41 or 42, including using the hot fluid and cold fluid in a heat engine, such as an ORC generator or a Kalina generator, to generate electricity.

Clause 43. The method of any preceding clause, wherein producing electricity and heat using the energy module includes directing solar rays to a first solar receiver that produces electricity and heat and to a second solar receiver that produces heat, circulating a first hot fluid in the first solar receiver and a second hot fluid in the second receiver.

Clause 44. The method of the preceding clause, including exchanging heat between the second hot fluid exchanges heat and the regeneration stream, and storing the first hot fluid in the hot storage pit without exchanging heat with the regeneration stream, optionally for use in the heat engine.

Clause 45. The method of any preceding clause, wherein the capture material is a solvent, a sorbent, a ion exchange unit.

Clause 46. The method of any preceding clause, wherein the gas is atmospheric air, post-combustion flue gas, a natural gas.

Clause 47. The method of any preceding clause, wherein the gas and the capture unit contact in one or more packed beds, a rotating packed bed, an absorption column, structured sorbent for circulating the gas counter current with the capture material.

Clause 48. A method for CO2 capture comprising: producing electrical power and heat from solar energy using an energy module, wherein producing electrical power and heat includes: receiving solar rays at one or more solar receivers, wherein at least one of the solar receiver includes a photovoltaic panel, converting a first portion of the solar energy into electricity including the photovoltaic panel, circulating a hot fluid in the solar receiver to recover a second portion of the energy from the solar rays and storing the hot fluid in a hot storage pit, optionally thermally insulated, and powering a refrigeration unit to cool a cold fluid and storing the cold fluid in a cold storage pit, optionally thermally insulated, the refrigeration unit being optionally powered by the electricity generated by the photovoltaic panel; capturing CO2 from a gas using a capture material; regenerating the loaded capture material, including unloading the CO2 from the loaded capture material, using a regeneration stream; and using at least a portion of the heat and/or electricity produced by the energy module for heating a regeneration stream, including: in a first configuration, exchanging heat with the hot fluid using one or more of a heat exchanger and/or powering one or more first heating units using the electricity produced by the photovoltaic panel, and in a second configuration, using the hot fluid and cold fluid to run a heat engine generating electricity and using the generated electricity to power one or more second heating elements, wherein optionally the second heating units include the first heating unit and additional heating units.

Clause 49. The method of clause 48, including running the heat engine and using the heat according to the second configuration upon sensing a temperature of the regeneration stream, optionally sensing that the temperature is below a threshold.

Clause 50. The system or method of any preceding clause, wherein the energy module further includes a first solar tower and a second solar tower, and the first solar tower includes a photovoltaic module and a first thermal receiver and the second solar tower includes a second thermal receiver and has no photovoltaic module.

Clause 51. The system or method of clause 50, wherein the first thermal receiver is configured to heat a high-temperature fluid to a first temperature greater than 100° C. and the second thermal receiver is configured to receive the high-temperature fluid from the first thermal receiver and heat the high-temperature fluid to a second temperature greater than 120° C.

Clause 52. A method for CO2 capture comprising producing electrical power and heat from solar energy using an energy module, wherein producing electrical power and heat includes: receiving solar rays at one or more solar receivers, wherein at least one of the solar receiver includes a photovoltaic panel, converting a first portion of the solar energy into electricity including the photovoltaic panel, circulating a hot fluid in the solar receiver to recover a second portion of the energy from the solar rays and storing the hot fluid in a hot storage pit, and capturing CO2 from a gas using a capture material to form a loaded capture material; regenerating the loaded capture material, including unloading the CO2 from the loaded capture material, using a regeneration stream; and using at least a portion of the heat and/or electricity produced by the energy module for heating the regeneration stream, including: in a first configuration, using the hot fluid to heat the regeneration stream, and in a second configuration, using the hot fluid to operate a thermal cycle generator to generate electricity and using the generated electricity to power a heating unit.

Clause 53. A CO2 capture installation, comprising a CO2 capture module, including a capture unit for capturing CO2 from a gas using a capture material and a regeneration unit for unloading the CO2 from a loaded capture material and regenerating said loaded capture material using heat; and an energy module for producing electrical power and heat using solar energy, wherein at least a portion of the heat produced in the energy module is used in the regeneration unit.

Clause 54. The CO2 capture installation of Clause 53, wherein the heat produced in the energy module is used to heat a regeneration stream to be circulated in the regeneration unit to a temperature greater than 90° C.

Clause 55. The CO2 capture installation of Clause 54, wherein the energy module includes a solar receiver for receiving solar rays, a hot fluid circulating in the solar receiver to recover thermal energy from the solar rays and a hot energy storage (HES) for storing the hot fluid.

Clause 56. The CO2 capture installation of Clause 55, comprising one or more heat exchangers for exchanging heat between the hot fluid and the regeneration stream.

Clause 57. The CO2 capture installation of Clause 56, wherein the heat exchanger includes a heat storing installation comprising solid heat storing units, such as refractory bricks, configured so that the hot fluid and the regeneration stream both exchange heat with the solid heat storing units.

Clause 58. The CO2 capture installation of any of Clauses 53-57, including a heat pump wherein the hot fluid circulates in an evaporator of the heat pump, and the regeneration stream circulates in a condenser of said heat pump.

Clause 59. The CO2 capture installation of Clause 58, further comprising one or more heat exchangers for exchanging heat between the hot fluid and the regeneration stream and including a controller for powering the heat pump based on a temperature of the regeneration stream at an outlet of the heat exchanger.

Clause 60. The CO2 capture installation of any Clauses 54-59, comprising a regeneration stream line for carrying the regeneration stream to the regeneration unit, wherein a heat exchanger is situated in the regeneration stream line upstream from a condenser of a heat pump, so that the regeneration stream has a first temperature at an outlet of the heat exchanger and has a second temperature higher than the first temperature at an outlet of the heat pump.

Clause 61. The CO2 capture installation of any Clauses 53-60, wherein the energy module includes a photovoltaic module and generates solar electrical power.

Clause 62. The CO2 capture installation of the preceding Clause, wherein the solar electrical power is used to power at least one element of the CO2 capture module.

Clause 63. The CO2 capture installation of Clause 61 or 62, wherein the energy module further includes a refrigeration unit to cool a cold fluid of a cold energy storage (CES), and the solar electrical power generated by a photovoltaic module of the energy module is used to power the refrigeration unit.

Clause 64. The CO2 capture installation of any Clauses 53-63, wherein energy module further includes a thermal cycle generator.

Clause 65. The CO2 capture installation of any Clauses 53-64, wherein the energy module further includes a first solar receiver including a photovoltaic module and a thermal receiver configured to heat a fluid at a temperature less than 100° C. and a second solar receiver including one or more thermal receivers configured to heat a high-temperature fluid to a temperature greater than 100° C.

Clause 66. The CO2 capture installation of Clause 65, including a high temperature energy storage (HTES) connected to the outlet of at least one of the one or more thermal receivers to store at least a portion of the high temperature fluid.

Clause 67. The CO2 capture installation of Clause 65 or 66; having a first thermal receiver configured to heat the high temperature fluid to a first temperature greater than 100C and a second thermal receiver configured to receive the high temperature fluid from the first thermal receiver and heat the high temperature fluid to a second temperature greater than 120C.

Clause 68. A method for CO2 capture comprising producing solar electrical power and solar thermal energy from solar energy using an energy module; capturing CO2 from a gas using a capture material to form a loaded capture material; and regenerating the loaded capture material, including unloading the CO2 from the loaded capture material using heat, wherein at least a portion of the solar thermal energy produced by the energy module is used in the regenerating of the loaded capture material.

Clause 69. The method of Clause 68, wherein regenerating the loaded capture material includes heating a regeneration stream to a temperature greater than 90° C. using the portion of the solar thermal energy.

Clause 70. The method of Clause 68 or 69, wherein producing solar thermal energy from solar energy includes receiving solar rays at least at a solar receiver, circulating a fluid in the solar receiver to recover solar thermal energy from the solar rays and storing at least a portion of the hot fluid in a hot energy storage (HES).

Clause 71. The method of Clause 70, the at least one solar receiver includes one or more PV modules to generate solar thermal energy and electricity from solar energy and one or more thermal receivers, wherein circulating the fluid in the PV module yields a hot fluid at a temperature of the hot fluid above 80° C. and below 100° C., and wherein circulating the fluid in the one or more thermal receivers yields a high-temperature fluid at a temperature above 100° C.

Clause 72. The method of Clause 71, further comprising storing at least a portion of the high-temperature fluid in a high-temperature energy storage (HTES) and using at least a portion of the solar thermal energy from the HTES to heat the loaded capture material.

Clause 73. A method for CO2 capture comprising: producing electrical power and heat from solar energy using an energy module, wherein producing electrical power and heat includes: receiving solar rays at one or more solar receivers, wherein at least one of the solar receiver includes a photovoltaic panel, converting a first portion of the solar energy into electricity including the photovoltaic panel, circulating a hot fluid in the solar receiver to recover a second portion of the energy from the solar rays and storing the hot fluid in a hot storage pit, and capturing CO2 from a gas using a capture material to form a loaded capture material; regenerating the loaded capture material, including unloading the CO2 from the loaded capture material, using a regeneration stream; and using at least a portion of the heat and/or electricity produced by the energy module for heating the regeneration stream, including in a first configuration, using the hot fluid to heat the regeneration stream, and in a second configuration, using the hot fluid to operate a thermal cycle generator to generate electricity and using the generated electricity to power a heating unit.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

1. A CO2 capture installation, comprising:
a CO2 capture module, including a capture unit for capturing CO2 from a gas using a capture material and a regeneration unit for unloading the CO2 from a loaded capture material and regenerating said loaded capture material using heat; and
an energy module for producing electrical power and heat using solar energy, wherein at least a portion of the heat produced in the energy module is used in the regeneration unit.

2. The CO2 capture installation of claim 1, wherein the heat produced in the energy module is used to heat a regeneration stream to be circulated in the regeneration unit to a temperature greater than 90° C.

3. The CO2 capture installation of claim 2, wherein the energy module includes a solar receiver for receiving solar rays, a hot fluid circulating in the solar receiver to recover thermal energy from the solar rays and a hot energy storage (HES) for storing the hot fluid.

4. The CO2 capture installation of claim 3, comprising one or more heat exchangers for exchanging heat between the hot fluid and the regeneration stream.

5. The CO2 capture installation of claim 4, wherein the heat exchanger includes a heat storing installation comprising solid heat storing units, such as refractory bricks, configured so that the hot fluid and the regeneration stream both exchange heat with the solid heat storing units.

6. The CO2 capture installation of claim 2, including a heat pump wherein the hot fluid circulates in an evaporator of the heat pump, and the regeneration stream circulates in a condenser of said heat pump.

7. The CO2 capture installation of claim 6, further comprising one or more heat exchangers for exchanging heat between the hot fluid and the regeneration stream and including a controller for powering the heat pump based on a temperature of the regeneration stream at an outlet of the heat exchanger.

8. The CO2 capture installation of claim 2, comprising a regeneration stream line for carrying the regeneration stream to the regeneration unit, wherein a heat exchanger is situated in the regeneration stream line upstream from a condenser of a heat pump, so that the regeneration stream has a first temperature at an outlet of the heat exchanger and has a second temperature higher than the first temperature at an outlet of the heat pump.

9. The CO2 capture installation of claim 1, wherein the energy module includes a photovoltaic module and generates solar electrical power.

10. The CO2 capture installation of claim 9, wherein the solar electrical power is used to power at least one element of the CO2 capture module.

11. The CO2 capture installation of claim 9, wherein the energy module further includes a refrigeration unit to cool a cold fluid of a cold energy storage (CES), and the solar electrical power generated by a photovoltaic module of the energy module is used to power the refrigeration unit.

12. The CO2 capture installation of claim 1, wherein energy module further includes a thermal cycle generator.

13. The CO2 capture installation of claim 1, wherein the energy module further includes a first solar receiver including a photovoltaic module and a thermal receiver configured to heat a hot fluid at a temperature less than 100° C. and at least a second solar receiver including one or more thermal receivers configured to heat a high-temperature fluid to a temperature greater than 100° C.

14. The CO2 capture installation of claim 13, including a high temperature energy storage (HTES) connected to the outlet of to at least one of the one or more thermal receivers to store at least a portion of the high temperature fluid.

15. A method for CO2 capture comprising:
producing solar electrical power and solar thermal energy from solar energy using an energy module;
capturing CO2 from a gas using a capture material to form a loaded capture material; and
regenerating the loaded capture material, including unloading the CO2 from the loaded capture material using heat, wherein at least a portion of the solar thermal energy produced by the energy module is used in the regenerating of the loaded capture material.

16. The method of claim 15, wherein regenerating the loaded capture material includes heating a regeneration stream to a temperature greater than 90° C. using the portion of the solar thermal energy.

17. The method of claim 15, wherein producing solar thermal energy from solar energy includes receiving solar rays at least at a solar receiver including a PV module, circulating a fluid in the solar receiver to recover solar thermal energy from the solar rays and storing at least a portion of the hot fluid in a hot energy storage (HES).

18. The method of claim 17, wherein the solar receiver is a first solar receiver, and the fluid circulates from the first solar receiver to a second solar receiver including a thermal receiver configured to further heat the fluid into a high-temperature fluid with a temperature greater than 100° C.

19. The method of claim 18, further comprising storing at least a portion of the high-temperature fluid in a high-temperature energy storage (HTES) and using at least a portion of the solar thermal energy from the HTES to heat the loaded capture material.

20. A method for CO2 capture comprising:
producing electrical power and heat from solar energy using an energy module, wherein
producing electrical power and heat includes:
receiving solar rays at one or more solar receivers, wherein at least one of the solar receiver includes a photovoltaic panel, converting a first portion of the solar energy into electricity including the photovoltaic panel, circulating a hot fluid in the solar receiver to recover a second portion of the energy from the solar rays and storing the hot fluid in a hot storage pit, and
capturing CO2 from a gas using a capture material to form a loaded capture material;
regenerating the loaded capture material, including unloading the CO2 from the loaded capture material, using a regeneration stream; and
using at least a portion of the heat and/or electricity produced by the energy module for heating the regeneration stream, including:
in a first configuration, using the hot fluid to heat the regeneration stream, and
in a second configuration, using the hot fluid to operate a thermal cycle generator to generate electricity and using the generated electricity to power a heating unit.
